(19) United States
(12) Patent Application Publication
(10) Pub. No.: US 2010/0133974 A1
(43) Pub. Date: Jun. 3, 2010

(54) Plasma display panel

(76) Inventors: Young-Suk Cho, Suwon-si (KR); Myun-Gi Shim, Suwon-si (KR); Hyun-Ki Park, Suwon-si (KR); Dong-Gun Moon, Suwon-si (KR); Sang-Yeol Hur, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/591,425

(22) Filed: Nov. 19, 2009

(30) Foreign Application Priority Data
Dec. 2, 2008 (KR) 10-2008-0121271

(51) Int. Cl. H01J 61/40

(52) U.S. Cl. 313/110

(57) ABSTRACT

A plasma display panel including a front substrate on which a plurality of discharge electrodes for generating a discharge are formed, a rear substrate on which barrier ribs partitioning discharge cells are formed, the rear substrate being disposed to face the front substrate, and a light absorption layer disposed between the discharge electrodes and the front substrate, the light absorption layer being formed of a plurality of metal particles, and the discharge electrodes being formed of a plurality of extension portions that are grown using the metal particles as seeds, whereby the light absorption layer reduces the reflectivity of the external light.

### BACKGROUND

1. Field

Embodiments relate to a plasma display panel (PDP) and, more particularly, to a PDP having reduced reflectivity of external light.

2. Description of the Related Art

A conventional three-electrode, alternating current (AC) surface discharge PDP includes a first substrate, a second substrate facing the first substrate, pairs of discharge sustaining electrodes including X electrodes and Y electrodes formed on an inner surface of the first substrate, a first dielectric layer covering the discharge sustaining electrode pairs, a protection layer coated on a surface of the first dielectric layer, an address electrode formed on an inner surface of the second substrate and arranged across the discharge sustaining electrode pairs, a second dielectric layer covering the address electrode, barrier ribs arranged between the first and second substrates, and red, green, and blue phosphor layers formed in discharge cells.

Conventional X electrodes include X transparent electrodes formed of a transparent material, e.g., an ITO layer, and X bus electrodes electrically connected to the X transparent electrodes and formed of a metal, e.g., a Ag paste. Conventional Y electrodes include Y transparent electrodes and Y bus electrodes having respectively the same characteristics as that of the X electrodes described above.

Frit glass is coated on the boundaries of each of the opposing surfaces of the first and second substrates to hermetically seal the discharge space from the outside. A discharge area is formed by injecting a discharge gas in the inner space between the first and second substrates.

In the above-described PDP, discharge cells are selected by applying electrical signals to the Y electrodes and the address electrodes, and then electrical signals are applied alternately to the X and Y electrodes to generate a surface discharge from a surface of the first substrate, thereby generating ultraviolet lights. Thus, visible light is emitted from the phosphor layer of the selected discharge cells, thereby realizing still or moving images.

Since the red, green, and blue phosphor layers appear white in general, the reflectivity thereof with respect to visible light is high.

### SUMMARY

Embodiments are therefore directed to a PDP, which substantially overcome one or more of the problems due to the limitations and disadvantages of the related art.

It is therefore a feature of an embodiment to provide a PDP including a light absorption layer, which is a metal thin layer, to reduce the reflectivity of external light.

At least one of the above and other features and advantages may be realized by providing a PDP that includes a front substrate on which a plurality of discharge electrodes for generating a discharge are formed, a rear substrate on which barrier ribs partitioning discharge cells are formed, the rear substrate being disposed to face the front substrate, and a light absorption layer disposed between the discharge electrodes and the front substrate, the light absorption layer being formed of a plurality of metal particles, and the discharge electrodes being formed of a plurality of extension portions that are grown using the metal particles as seeds.

The light absorption layer may be formed of an alloy of nickel and a metal, the metal also forms the discharge electrodes.

An alloy ratio of the nickel to the metal in the light absorption layer may be about 1:1 to about 9:1.

The light absorption layer may further include at least one of silicon (Si), iron (Fe), or magnesium (Mn).

The discharge electrodes may include at least one of aluminum (Al), silver (Ag), and copper (Cu).

The light absorption layer may have a dark color which may absorb external light.

The light absorption layer may be black.

A thickness of the light absorption layer may be about 1 nm to 1000 nm.

A reflectivity of the light absorption layer may be about 50% or less.

The extension portions of the discharge electrode may have the shape of columns.

The discharge electrodes may be formed using one of an ion plating method, a thermal deposition method, a sputtering method, and a chemical deposition method.

The PDP may further include a transparent electrode layer disposed between the front substrate and the light absorption layer.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a partial, exploded perspective view of a PDP according to an embodiment;

FIG. 2 illustrates an enlarged view of a portion A of the PDP of FIG. 1;

FIG. 3 is a scanning electronic microscope (SEM) photograph showing a longitudinal cross-section of a discharge electrode and a light absorption layer arranged on a front substrate of the PDP of FIG. 1;

FIG. 4 is a SEM photograph showing an upper surface of the discharge electrode of the PDP of FIG. 1; and

FIG. 5 illustrates a perpendicular, cross-sectional view of a front substrate, a transparent electrode layer, a light absorption layer, and a discharge electrode of a PDP according to another embodiment.

### DETAILED DESCRIPTION

Korean Patent Application No. 10-2008-0121271, filed on Dec. 2, 2008, in the Korean Intellectual Property Office, and entitled: “Plasma Display Panel,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

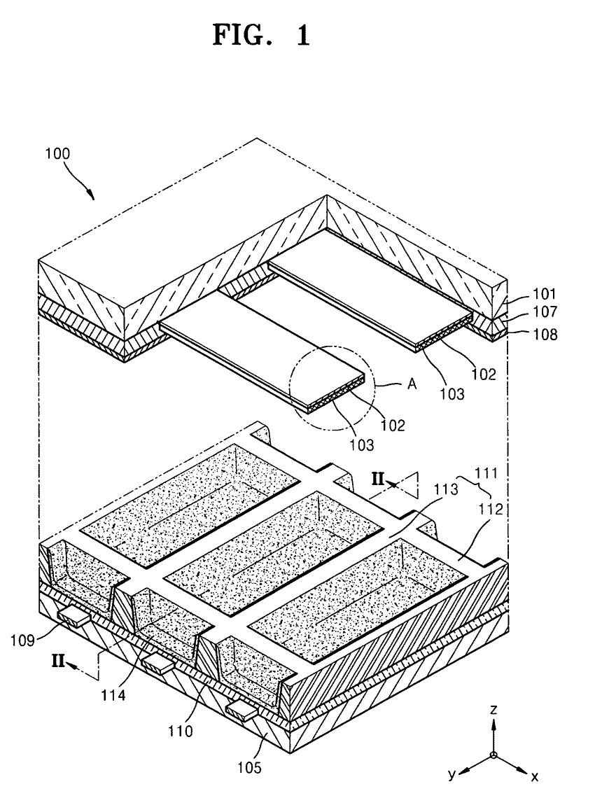

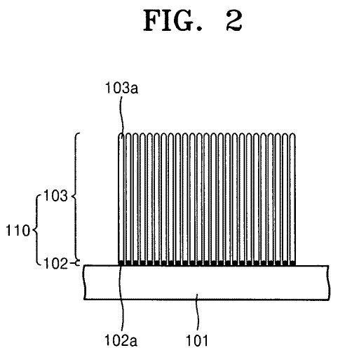

FIG. 1 illustrates a partial, exploded perspective view of a PDP 100 according to an embodiment, and FIG. 2 illustrates an enlarged view of a portion A of the PDP of FIG. 1.

Referring to FIGS. 1 and 2, the PDP 100 may include a front substrate 101 and a rear substrate 105 facing the front substrate 101. A sealing material (not shown), e.g., frit glass, may be coated on the front substrate 101 and the inner boundaries of the rear substrate 105 facing the front substrate 101. The sealing material may seal a discharge space from the outside when the front substrate 101 and the rear substrate 105 are encapsulated.

The front substrate 101 may be formed of a transparent material, e.g., soda lime glass or PD-200 glass¹. Discharge electrodes 103 may be arranged on the inner surface of the front substrate 101, each extending parallel to adjacent discharge electrode along an x-axis direction. Alternatively, the discharge electrodes 103 may be arranged on the inner surface of the front substrate 101, each extending parallel to adjacent one along a y-axis direction. One pair of the discharge electrodes 103 may be positioned in each discharge cell. ¹ Manufactured by Asahi Glass Co., Ltd., Japan.

A light absorption layer 102 may be arranged between the front substrate 101 and the discharge electrodes 103. The light absorption layer 102 may be formed of a nickel (Ni) alloy. A metal included in the nickel alloy that forms the light absorption layer 102 may be the same metal that forms the discharge electrodes 103. The discharge electrodes 103 may be formed of at least one of aluminum (Al), silver (Ag), and copper (Cu). Accordingly, for example, when the discharge electrodes 103 are formed of aluminum (Al), the light absorption layer 102 may be formed of Ni—Al alloy. Further, when the discharge electrodes 103 are formed of silver (Ag), the light absorption layer 102 may be formed of Ni—Ag alloy. Also, when the discharge electrodes 103 are formed of copper (Cu), the light absorption layer 102 may be formed of Ni—Cu alloy. By forming the light absorption layer 102 with the nickel alloy that contains the metal that is also used to form the discharge electrode 103, bonding formed on the light absorption layer 102 between the discharge electrodes 103 and the light absorption layer 102 may be stronger. Accordingly, deformation due to cracks or hill rocks that may occur between the discharge electrodes 103 and the light absorption layer 102 during a firing process may be prevented.

The alloy ratio of nickel (Ni) and the metal that also forms the discharge electrodes 103 may be about 1:1 to about 9:1. In detail, the alloy ratio of nickel (Ni) to aluminum (Al) may preferably be about 6:1. Since nickel is included in the alloy, the light absorption layer 102 may have a dark color capable of absorbing external light. The light absorption layer may be black. The reflectivity of the light absorption layer 102 may be about 50% or less.

Referring to FIG. 2, the light absorption layer 102 may be formed of a plurality of metal particles 102a. The metal particles 102a may be formed of the nickel alloy and thus, also may be black. In FIG. 2, the light absorption layer 102 may be illustrated as a single layer formed of the metal particles 102a, but the present embodiment is not limited thereto, and the light absorption layer 102 may be formed of a plurality of layers of the metal particles 102a. The metal particles 102a may be separated from one another at predetermined distances. The metal particles 102a may function as seeds when forming the discharge electrodes 103. That is, the discharge electrode 103 may be grown, e.g., extend, along a certain direction using the metal particles 102a as seeds, as will be described in detail later.

In general, the front substrate 101 may be formed of glass, and the light absorption layer 102 may be formed of the nickel alloy. Therefore, the front substrate 101 and the light absorption layer 102 may be separated from each other during a wet process like etching. Also, due to the difference in the thermal expansion coefficients of the front substrate 101 and the light absorption layer 102, a deformation may be generated during a thermal process, e.g., a firing process. Accordingly, silicon (Si), iron (Fe), or manganese (Mn) may be further included in the nickel alloy to prevent a deformation from occurring and to increase the adhesion force between the front substrate 101 and the light absorption layer 102.

A thickness of the light absorption layer 102 may be about 1 nm to about 1000 nm. If the thickness of the light absorption layer 102 is greater than about 1000 nm, a resistance may be increased. If the resistance increases, a voltage decrease may become greater, requiring a larger amount of driving power to be consumed and, as the result, slowing down the response speed. If the thickness of the light absorption layer 102 is less than about 1 nm, an absorption ratio of the external light may be decreased. Accordingly, the thickness of the light absorption layer 102 may preferably be about 1 nm to about 1000 nm. The light absorption layer 102 may be formed using a deposition method, e.g., a thermal deposition method, a chemical deposition method, and so forth.

The discharge electrode 103 may be formed on the light absorption layer 102.

In detail, the discharge electrode 103 may be formed of a plurality of extension portions 103a which are grown using the metal particles 102a of the light absorption layer 102 as seeds or cores. The extension portions 103a may grow from the metal particles 102a over the front substrate 101 and may have the shape of columns.

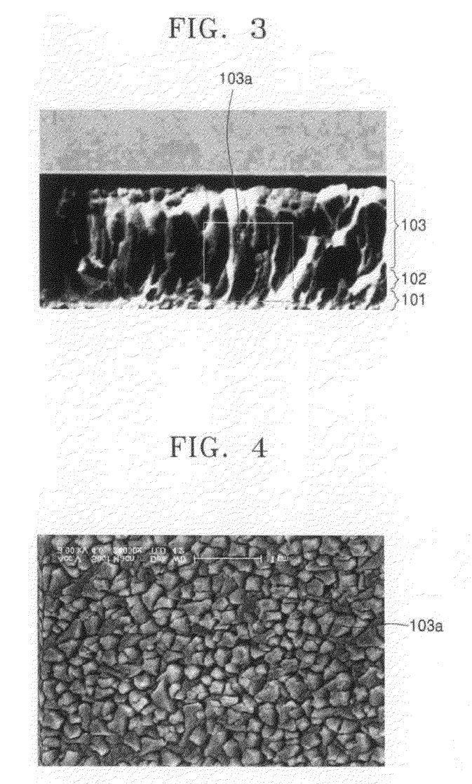

FIGS. 3 and 4 are scanning electron microscope (SEM) photographs showing the discharge electrodes 103 and the light absorption layer 102 arranged on the front substrate 101. FIG. 3 is a SEM photograph showing a longitudinal cross-section of the discharge electrodes 103 and the light absorption layer 102 arranged on the front substrate 101. FIG. 4 is a SEM photograph showing an upper surface of the discharge electrodes 103. The discharge electrodes 103 as shown in FIGS. 3 and 4 are formed of aluminum (Al), and the light absorption layer 102 are formed of Ni—Al alloy. In particular, the alloy ratio of nickel to aluminum of the light absorption layer 102 may be about 6:1. As can be seen from FIG. 3, the extension portions 103a are grown from the light absorption layer 102. The discharge electrodes 103 are formed of a plurality of extension portions 103a, as shown in FIG. 4.

In the comparative art, a black matrix may be arranged between a front substrate and a discharge electrode to reduce the reflectivity of external light. A thick film electrode formed using a paste containing a black pigment or a black metal thin layer has been used as the black matrix. If the thick film electrode is used, it may, however, require that discharge electrodes be also formed of thick layers. Furthermore, if the black metal thin layer is used as the black matrix, it may have high reflectivity. In contrast, according to an embodiment, the light absorption layer 102 may be formed of a plurality of metal particles 102a, and thus, light incident from the outside may be diffused and absorbed into the metal particles 102a of the light absorption layer 102. Discharge electrodes 103 formed of a metal, e.g., aluminum (Al), also have high reflectivity, and thus, light that has passed through the light absorption layer 102 may be reflected again on the discharge electrodes 103. However, the light reflected on the discharge electrodes 103 may be diffused and absorbed into the light absorption layer 102. Accordingly, the reflectivity of the external light of the PDP according to an embodiment may be reduced, and thus, an ambient contrast may be increased.

Referring back to FIG. 1, the discharge electrodes 103 may be covered by a first dielectric layer 107. The first dielectric layer 107 may be formed by mixing various fillers into a glass paste.

A protection layer 108, e.g., a magnesium oxide (MgO) layer, may be formed on a surface of the first dielectric layer 107 to prevent the first dielectric layer 107 from being damaged and to increase the emission of second electrons.

The rear substrate 105 may preferably be formed of the same material as the front substrate 101, and depending on whether the PDP 100 is transmissive or reflective, various, selective combinations of materials may possibly be used as the material to form the rear substrate 105 or the front substrate 101.

A plurality of address electrodes 109 may be arranged in an inner surface of the rear substrate 105. The address electrodes 109 may be arranged in a direction to cross the discharge electrodes 103, e.g., y-axis direction. The address electrodes 109 may be covered by a second dielectric layer 110.

Barrier ribs 111 may be formed between the front substrate 101 and the rear substrate 105, partitioning discharge cells between the front substrate 101 and the rear substrate 105. The barrier ribs 111 may include first barrier ribs 112 arranged in a direction, e.g., x-axis direction, crossing the address electrodes 109 and second barrier ribs 113 arranged, e.g., y-axis direction, parallel to the address electrodes 109. The combined first barrier ribs 112 and the second barrier ribs 113 may define a closed discharge space, e.g., a matrix type discharge space.

Alternatively, the structure of the first barrier ribs 112 and the second barrier ribs 113 may be, e.g., a meander type, a delta type, or a honeycomb type, etc., and a discharge space partitioned by the first barrier ribs 112 and the second barrier ribs 113 may have a polygonal shape other than a tetragonal shape, or a circular or oval shape. The embodiments are not limited to one shape of the discharge space.

Red, green, and blue phosphor layers 114, which emit light for realizing an image, may be coated in the discharge space defined by the barrier ribs 111. The phosphor layers 114 may include red, green, and blue phosphor layers. The red phosphor layer may preferably be formed of (Y,Gd)BO₃;Eu⁺³, the green phosphor layer may preferably be formed of Zn₂SiO₄:Mn²⁺, and the blue phosphor layer may preferably be formed of BaMgAl₁₀O₁₇:Eu²⁺.

Meanwhile, a discharge gas such as neon-xenon (Ne—Xe) or helium-xenon (He—Xe) may be injected in the discharge cells partitioned by the front substrate 101, the rear substrate 105, and the barrier ribs 111.

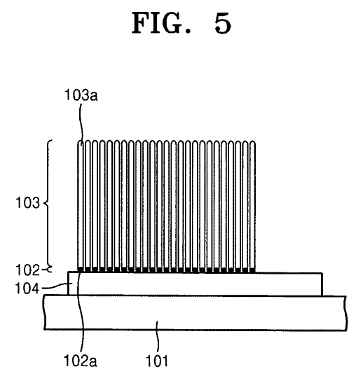

FIG. 5 illustrates a perpendicular, cross-sectional view of a front side of a

PDP according to another exemplary embodiment, wherein the light absorption layer 102, the metal particles 102a, the discharge electrodes 103, and the extension portion 103a are the same as those of the PDP according to the exemplary embodiment described above. The PDP of FIG. 5 may be different from the PDP of FIG. 1 in that a transparent electrode layer 104 may be further included. Referring to FIG. 5, the transparent electrode layer 104 may be disposed between the front substrate 101 and the light absorption layer 102 in the PDP according to the current embodiment. The light absorption layer 102 may be formed of metal particles 102a.

When looking at the PDP in a bright environment, the reflected light is shown together with the light emitted from inside of the PDP, and thus, the ambient contrast is decreased. In the PDP according to the present invention, light incident on the PDP from the outside may be diffused and absorbed into the light absorption layer, which is a metal thin layer, and thus, may increase the ambient contrast of the PDP by reducing the reflectivity of the light from the outside.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
a front substrate on which a plurality of discharge electrodes for generating a discharge are formed;
a rear substrate on which barrier ribs partitioning discharge cells are formed, the rear substrate being disposed to face the front substrate, and
a light absorption layer disposed between the discharge electrodes and the front substrate, the light absorption layer being formed of a plurality of metal particles and the discharge electrodes being formed of a plurality of extension portions that are grown using the metal particles as seeds.

2. The PDP as claimed in claim 1, wherein the light absorption layer is formed of an alloy of nickel and a metal, the metal also forming the discharge electrodes.

3. The PDP as claimed in claim 2, wherein an alloy ratio of the nickel to the metal in the light absorption layer is about 1:1 to about 9:1.

4. The PDP as claimed in claim 2, wherein the alloy of nickel that forms the light absorption layer further includes at least one of silicon (Si), iron (Fe), or manganese (Mn).

5. The PDP as claimed in claim 2, wherein the discharge electrodes includes at least one of aluminum (Al), silver (Ag), and copper (Cu).

6. The PDP as claimed in claim 1, wherein the light absorption layer has a dark color which can absorb external light.

7. The PDP as claimed in claim 6, wherein the light absorption layer is black.

8. The PDP as claimed in claim 1, wherein a thickness of the light absorption layer is about 1 nm to about 1000 nm.

9. The PDP as claimed in claim 1, wherein a reflectivity of the light absorption layer is about 50% or less.

10. The PDP as claimed in claim 1, wherein the extension portions of the discharge electrode have the shape of columns.

11. The PDP as claimed in claim 1, wherein the discharge electrodes are formed using one of an ion plating method, a thermal deposition method, a sputtering method, and a chemical deposition method.

12. The PDP as claimed in claim 1, further comprising a transparent electrode layer disposed between the front substrate and the light absorption layer.
